(19) United States
(12) Patent Application Publication
(10) Pub. No.: US 2022/0087091 A1
(43) Pub. Date: Mar. 24, 2022

(54) DEVICE AND METHOD FOR SAFELY OPERATING AN AUTONOMOUSLY OPERABLE AGRICULTURAL MACHINE

(71) Applicants: ZF Friedrichshafen AG, Friedrichshafen (DE); Horsch Maschinen GmbH, Schwandorf (DE); Horsch Leeb Application Systems GmbH, Oberpoering (DE)

(72) Inventors: David Nieto Lara, Tettnang (DE); Tommy Ikonen, Friedrichshafen (DE); Daniel Hirthammer, Schwandorf (DE); Theodor Leeb, Wallersdorf (DE)

(21) Appl. No.: 17/427,943

(22) PCT Filed: Feb. 3, 2020
(86) PCT No.: PCT/EP2020/052534

§ 371 Date: Aug. 3, 2021

(30) Foreign Application Priority Data
Feb. 5, 2019 (DE) 10 2019 000 792.1

(51) Int. Cl. A01B 69/00; A01B 79/00

(52) U.S. Cl. CPC A01B 69/001; A01B 79/005

(57) ABSTRACT

The present invention relates to a device (14) for safely operating an autonomously operable agricultural machine (12), said device comprising: an input interface (30) for receiving a sensor signal from an environment sensor (18) on the agricultural machine, said signal comprising information about objects in the surroundings of the agricultural machine; a processing unit (32) for recognizing a fault situation based on the sensor signal; a classification unit (34) for assigning the recognized fault situation to a fault class based on a predefined assignment rule; and a transmission interface (36) for periodically transmitting a message to a control device (16) of the agricultural machine via a vehicle bus system (20) of the agricultural machine, said message comprising the fault class if the fault situation was recognized. The present invention also relates to a method and a system (10) for safely operating an autonomously operable agricultural machine (12).

### CROSS REFERENCE TO RELATED APPLICATIONS

This application is a U.S. National Phase application under 35 U.S.C. § 371 of International Application No. PCT/EP2020/052534, filed on Feb. 3, 2020, and claims benefit to German Patent Application No. DE 10 2019 000 792.1, filed on Feb. 5, 2019. The International Application was published in German on Aug. 13, 2020 as WO 2020/161035 A1 under PCT Article 21(2).

### FIELD

The present disclosure relates to a device for safely operating an autonomously operable agricultural machine. The present disclosure furthermore relates to a method and a system for safely operating an autonomously operable agricultural machine and to an autonomously operable agricultural machine.

### BACKGROUND

More and more modern agricultural machines (soil cultivating machines, field sprayers, transporters, seeders, tractors, etc.) offer possibilities for autonomous or semi-autonomous operation. Especially since agricultural machines are used predominantly on fields or outside of high-traffic areas and the work to be performed is often recurring, autonomous approaches can be implemented with relatively little effort. Self-propelled vehicles with implements operating largely or completely autonomously can be used in particular. This results in a high cost reduction potential due to such automation.

An important prerequisite is the detection and recognition of the surroundings of the agricultural machine. Sensor data with information concerning the surroundings are detected by means of environment sensors, such as radar, lidar, camera, or ultrasonic sensors. Based on these data, objects in the surroundings of the agricultural machine can be identified and classified. Starting therefrom, a behavior of the agricultural machine with respect to the driving and use of an implement can be adapted to a current situation.

In this connection, DE 10 2016 209 437 A1 relates to an automatic steering system for guiding an agricultural vehicle over a field on which a track was left during a preceding work process. The steering system comprises a camera viewing the track, an image processing system for processing image signals of the camera and a steering control system.

A position signal generated by the image processing system regarding a detected position of the track can be supplied to the steering control system. The image processing system is programmed to convert the image signal of the camera into a binary image and to recognize the track on the basis of a morphological operation on the binary image using a structural element representing the track.

A challenge consists in efficiently processing the sensor data of the environment sensors and controlling the actuators of the agricultural machine. Since the system integration in the field of agricultural machines has progressed less than in the field of passenger cars or trucks, it is often necessary to integrate a plurality of systems that are required for different functions.

### SUMMARY

In an embodiment, the present disclosure provides a device for safely operating an autonomously operable agricultural machine. The device includes an input interface configured to receive a sensor signal from an environment sensor on the agricultural machine, the sensor signal comprising information about objects in the surroundings of the agricultural machine. The device further includes a processor configured to recognize a fault situation based on the sensor signal, a classification unit configured to assign the recognized fault situation to a fault class based on a predefined assignment rule, and a transmission interface configured to periodically transmit a message to a control device of the agricultural machine via a vehicle bus system of the agricultural machine. The message includes the fault class.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a schematic representation of an agricultural machine with a system;

FIG. 2 a schematic representation of a device;

FIG. 3 a schematic representation of a further embodiment of an agricultural machine; and

FIG. 4 a schematic representation of a method.

### DETAILED DESCRIPTION

The present disclosure provides an approach for operating an autonomously operable agricultural machine. Efficient and reliable processing of sensor data and actuation of actuators should in particular be achieved. The safety of the agricultural machine and of objects in its surroundings is to be ensured. In addition, modular integrability of autonomous functions into existing agricultural machines is to be achieved as much as possible.

The present disclosure relates in a first aspect to a device for safely operating an autonomously operable agricultural machine, said device comprising: an input interface for receiving a sensor signal of an environment sensor on the agricultural machine, said signal comprising information about objects in the surroundings of the agricultural machine; a processing unit for recognizing a fault situation based on the sensor signal; a classification unit for assigning the recognized fault situation to a fault class based on a predefined assignment rule; and a transmission interface for periodically transmitting a message to a control device of the agricultural machine via a vehicle bus system of the agricultural machine, said message comprising the fault class if the fault situation was recognized.

In a further aspect, the present disclosure relates to a system for safely operating an autonomously operable agricultural machine, said system comprising: a device as described above; an environment sensor for recognizing objects in the surroundings of the agricultural machine; and a control device for receiving the message and for controlling a self-driving unit and/or an implement of the agricultural machine based on the received message.

In a further aspect, the present disclosure relates to an autonomously operable agricultural machine, said machine comprising: a system as described above; a vehicle bus system; and a self-driving unit for moving the agricultural machine and/or an implement for executing an agricultural task, in particular a field sprayer for spraying a substance.

Further aspects of the disclosure relate to a method corresponding to the device and to a computer program product comprising program code for carrying out the steps of the method when the program code is executed on a computer, and a storage medium on which a computer program is stored, which, when executed on a computer, effects an execution of the method described herein.

Preferred embodiments are described herein. It goes without saying that the features mentioned above and the features to be explained in more detail below can be used not only in the respectively stated combination but also in other combinations or alone. In particular, the device, the system, the agricultural machine, the method and the computer program product can be designed according to the embodiments described for the device, and the system.

The device or the method and system serve to ensure efficient communication between different units within an autonomously operable agricultural machine. A sensor signal of an environment sensor is received via an input interface. A fault situation can be recognized based on this signal. This fault situation is assigned to a predefined fault class. At predefined time intervals, messages are transmitted to a control device of the agricultural machine via a vehicle bus system. The vehicle bus system of the vehicle serves to connect a plurality of units connected thereto. The fault class of the fault situation is found in the periodically transmitted messages precisely when the fault situation was recognized. If no fault situation was recognized, empty messages are transmitted.

In this respect, the device only transmits information. The communication between the device and the control device of the agricultural machine is essentially unidirectional. The device sends messages to the central control device. The messages are processed in the vehicle control device. The control device serves to control a self-driving unit and/or an implement of the agricultural machine. Individual driving functions or other functions of the agricultural machine are thus actuated (based on the ascertained and transmitted fault class) only in the vehicle control device. Driving functions and/or implement functions in particular can be actuated.

By periodically transmitting the messages, efficient communication can be ensured. An overload of the vehicle bus system in critical situations, in which a plurality of units wants to simultaneously transmit messages, can be avoided. It is directly possible to establish whether a communication fault is present and no more messages arrive. Communication systems (in particular a vehicle bus system) present anyway in an agricultural machine can be used, as a result of which subsequent installability is achieved. Efficient communication between a plurality of units is enabled by using a vehicle bus system. Due to the simultaneous use of one communication channel by a plurality of systems, communication faults can be prevented to the greatest extent possible.

In comparison to previous approaches in which direct control of vehicle functions and/or implement functions takes place based on the sensor data of an environment sensor, simplified communication with lower load on the communication channel is achieved by the classification and periodic transmission. In addition, reliability is improved. In comparison to previous approaches in which direct control based on the sensor signal of the environment sensor takes place, communication is reduced and reliability is also increased.

In a preferred embodiment, the input interface is designed to receive the sensor signal via the vehicle bus system. One or more environment sensors are connected to the vehicle bus system and communicate via it with the device. A flexible configuration is made possible depending on the agricultural machine and the specific application requirements.

In one embodiment, the predefined assignment rule is based on a risk resulting from the fault situation for the agricultural machine and for objects in the surroundings of the agricultural machine. A higher risk entails a higher fault class. In other words, the fault classes indicate a risk to the agricultural machine and to objects in its surroundings. Processing is carried out which allows a predefined response to be carried out depending on the risk. Simple data processing is made possible.

In an advantageous embodiment, the transmission interface is designed to transmit a further message before a regular time period elapses when two fault situations are recognized. It is possible to transmit a second message after the first message before a regular time interval between the transmission of two messages has elapsed. This makes it possible to react flexibly if a plurality of fault situations is detected in rapid sequence. The safety of the agricultural machine and of the objects in the surroundings of the machine are improved. Flexibility for a response to changed circumstances or to further faults can be achieved if necessary.

In one embodiment, the input interface is designed to receive a status message of the control device of the agricultural machine via the vehicle bus system. It is possible for a confirmation to be transmitted back by the control device via a return channel in individual cases or in all cases. Confirmed communication can thereby be carried out and reliability or safety can be further improved.

In one embodiment, the processing unit is designed to ascertain a fault location and/or a fault type. The classification unit is designed to assign the recognized fault situation to a fault class based on the ascertained fault location and/or the ascertained fault type. The transmission interface is designed to periodically transmit the message with the ascertained fault location and/or the ascertained fault class. A fault location denotes, in particular, a position of the corresponding environment sensor on the agricultural machine. A fault type denotes in particular a description or classification of the fault. The fault type may, for example, be specified based on an assignment to a predefined group. The fault class then results from the fault location and fault type.

The transmission interface is preferably designed to periodically transmit the message with the ascertained fault location and/or the ascertained fault class. The ascertainment of a fault location and/or a fault type allows a simple assignment or classification of a fault, which in turn can then serve as the basis for ascertaining a corresponding response of the agricultural machine.

In one embodiment, the classification unit is designed to ascertain a response of the agricultural machine to the recognized fault situation. The transmission interface is designed to periodically transmit the message with the ascertained response. It is optionally possible for a response of the agricultural machine to be ascertained or proposed in the device. This response can then also be transmitted periodically. As a result, in a modular autonomous operating system of an agricultural machine, a module can be integrated in correspondence to the device, which module completely represents the response to fault situations (but without actuation of the actuators of the agricultural machine). Not only are faults recognized, but adequate responses of the agricultural machine are additionally proposed or specified. This enables simple subsequent integrability. In addition, efficient communication is ensured since only necessary information is transmitted.

In a preferred embodiment of the system, the control device is designed to set an operating state of the agricultural machine. Furthermore, the control device is designed to change from an autonomous operating state, in which the agricultural machine operates autonomously, into a remote-controlled operating state, in which the agricultural machine can be controlled remotely, if the fault class satisfies a predefined state condition. By setting an operating state, the safety of the agricultural machine and of objects in its surroundings can be increased. By changing from an autonomous operating state to a remote-controlled operating state, the response to a fault situation is transmitted to a human operator. A switching to manual operation takes place, so to speak, when a predefined state condition is satisfied. For example, this predefined state condition can be defined based on the risk resulting from the fault situation. In fault situations that pose a high risk, remote control by a human operator must take place.

In a further advantageous embodiment of the system, the control device is designed to brake the agricultural machine if the fault class satisfies a predefined braking condition. Preferably, the control device is designed to ascertain a braking force based on the fault class and to brake the agricultural machine with the ascertained braking force. The predefined braking condition can also be defined based on the risk resulting from the fault situation for the agricultural machine and for objects in its surroundings. Braking can take place in particular until the agricultural machine is stopped. A stationary machine usually does not represent any danger or represents only a minor danger to its vicinity. Depending on the danger, a weak or strong braking or emergency braking can be triggered and the braking force can be ascertained accordingly. Emergency braking can cause damage to the agricultural machine. Nevertheless, there are cases in which emergency braking is required because, for example, there is a risk of personal injury. It is possible for the braking force to be determined based on the fault class.

In a further advantageous embodiment, the system comprises an operator interface for receiving an input from an operator. The control device is designed to request an operator command via the operator interface if the fault class satisfies a predefined input condition. It is also possible for a human operator to be asked to perform an input if a specific condition is satisfied. An action instruction for specific fault classes can in particular be transmitted to the operator. The operator is asked to indicate via an operator command that they have performed the action instruction. By using an operator interface, an operator can be involved. Fault handling that requires an operator can be performed. This further improves safety during operation of the autonomously operable agricultural machine.

In an advantageous embodiment of the system, the control device is designed to carry out the response. The response is thereby proposed and transmitted by the device. If a response is transmitted, the control device can carry out a corresponding control of units of the agricultural machine (actuators) so that the response of the agricultural machine is carried out. This results in a modular and possibly subsequent installability.

An autonomously operable agricultural machine herein in particular denotes a machine that can move without intervention by a human operator and can perform an agricultural function/task. For example, a self-propelled field sprayer discharging a spray or another substance, or a self-propelled seeder discharging seeds. The agricultural machine in particular has a self-driving unit which enables a movement of the machine without control intervention by an operator, and an implement which performs an agricultural function without control intervention by an operator (actuators of the agricultural machine).

An operating state is in particular a state of the agricultural machine or a state of the control system of the agricultural machine. The control system comprises all of the various control and regulation units of the machine. An operating state can in particular be set or adjusted by transmitting control signals to corresponding sensors and actuators of the agricultural machine. The sensors and actuators then carry out a function or prevent a function. An area surrounding the agricultural machine comprises in particular a region in the vicinity of the agricultural machine visible from an environment sensor attached to the agricultural machine. An environment sensor can also comprise a plurality of sensors which, for example, enable a 360° panoramic view and can thus record a complete image of the surroundings. An object herein can be a static or a dynamic object. For example, trees, stones, pedestrians, people, animals, and other machines represent objects. A fault situation can both be due to a fault in the sensor and denote a potential or actual problem recognized based on the sensor signal. A vehicle bus system can in particular be a CAN bus. A fault situation can comprise in particular a fault type and a fault location. The predefined assignment rule may be based on a lookup table in which a class is assigned to a fault situation.

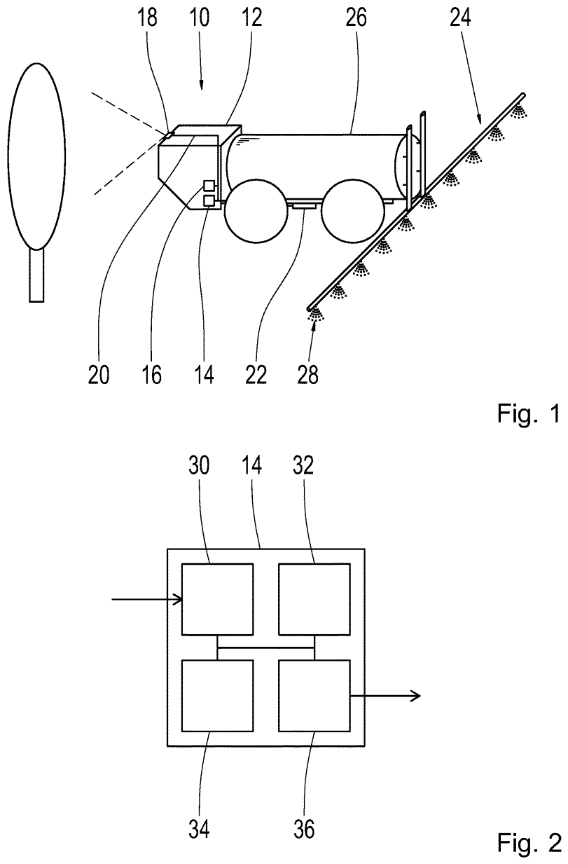

FIG. 1 schematically shows a system 10 for safely operating an autonomously operable agricultural machine 12. The system 10 comprises a device 14 and a control device 16 and an environment sensor 18. The agricultural machine 12 also comprises a vehicle bus system 20, which establishes a communication link between the various units, in particular between the device 14, the control device 16, and the environment sensor 18. Furthermore, the autonomously operable agricultural machine comprises a self-driving unit 22 and an implement 24.

In the example shown, an autonomously moving field sprayer is depicted as agricultural machine 12. The field sprayer serves to spray a liquid substance onto larger fields. For this purpose, the field sprayer comprises a liquid tank 26 which can be filled with a plant protection agent, for example. Furthermore, the field sprayer comprises a spraying device as implement 24. By means of the spraying device, the content of the liquid tank 26 can be delivered to a field or to the plants in the field. In the example shown, the spraying device is designed as a long and foldable cantilever, which makes it possible to discharge the liquid of the liquid tank 26 over a width of several meters by means of a plurality of nozzles 28 and a pump (not shown).

The agricultural machine operates autonomously, i.e., without operator. Autonomous movement is performed by the self-driving unit 22. Autonomous field processing is performed by the implement 24. Fault situations occurring during autonomous operation must be handled. In particular, it is necessary for the agricultural machine to carry out an adequate response and for the safety of the machine and of the objects in its surroundings to be ensured in the process. Fault situations can be, for example, dusty or dirty sensors, recognized obstacles, defective sensors, or even defective actuators. Responses of the agricultural machine can be, for example, emergency braking, slow braking until stoppage, slight braking in the sense of deceleration, strong braking, or even swerving. The response of the autonomous machine must be appropriate to the detection or the fault situation in order to ensure safe operation of the agricultural machine. In the field of agricultural machines, it is furthermore relevant that a subsequent installation or a modular integration of different units can often be carried out.

A sensor signal of the environment sensor 18 is processed in the device 14. A fault situation is recognized based on the sensor signal. This fault situation is assigned to a fault class, which is then communicated to the control device 16. The control device can actuate both the implement 24 and the self-driving unit 22 and initiate an adequate response of the agricultural machine 12 to the fault situation. In this respect, the self-driving functions and the functions of the implement 24 are actuated not by the device 14 itself but by the control device 16. Separating the functionality of recognizing and classifying the fault situation from actuating the vehicle functions results in simplified subsequent installability.

A device 14 is shown in FIG. 2. The device 14 comprises an input interface 30, a processing unit 32, a classification unit 34, and a transmission interface 36. The device 14 can, for example, be integrated as an additional module into the vehicle control device 16 of the agricultural machine 12 or can also be implemented as a physically separate module. It is possible for the device 14 to be partially or completely implemented in software and/or hardware. The units and interfaces can be designed individually or in combination as a processor, processor module, or software for a processor.

Sensor signals of one environment sensor or even a plurality of environment sensors are received via the input interface 30. Data from a radar, lidar, ultrasonic, or camera sensor can be received in particular. The received sensor signals comprise information about objects in the surroundings of the agricultural machine. In particular, the detections by an environment sensor comprise information about a spatial position of a detected object.

A fault situation is recognized in the processing unit 32 based on the received sensor signal. It is possible in particular for a fault code to be assigned. The fault code may, for example, be composed of a fault location (0-9999) and a fault type (0-999). In this respect, a fault location can identify, for example, a front-left camera of the agricultural machine. One fault type can be, for example, soiling of this camera. Artificial neural networks or other learning algorithms can, for example, be used for recognizing the fault situation.

In the classification unit 34, the recognized fault situation is then assigned to a fault class. A predefined assignment rule is used for this purpose. It can be specified in particular which fault class results from a specific fault code. For example, depending on the severity of the fault or depending on the magnitude of the risk arising from the fault situation, a different response of the traction drive can take place. Artificial neural networks or other learning algorithms can also be used for the classification, for example.

The fault class is transmitted to the control device of the agricultural machine via the transmission interface 36. Like the input interface, the transmission interface can also be implemented in software and/or in hardware. Communication preferably takes place unidirectionally. The transmission interface 36 is designed to transmit messages periodically, i.e., at regular time intervals. If a fault situation is not recognized, the transmitted message does not include a fault class.

It is possible for the control device to transmit a status message back to the transmission interface 36. For example, it can be transmitted back from the control device in a status message that an autonomous operating state or at least a pre-autonomous operating state is possible at the current point in time. If a status message indicating that the agricultural machine is not in the autonomous operating state at the moment is received, the transmission of messages or the handling of fault situations can be dispensed with.

It is also possible for a plurality of messages to be sent sequentially one after the other within a transmission cycle if a plurality of fault situations is recognized simultaneously or at a short time interval.

The input interface 30 and/or the transmission interface 36 can, for example, be implemented as a plug-in connection in hardware. It is also possible for the input interface 30 and/or the transmission interface 36 to be designed as corresponding software interfaces for receiving data. The interfaces can be designed in particular for communication via a CAN bus (vehicle bus system). In particular, the transmitted message may correspond to a CAN message or to a fault and diagnostic message.

An exemplary classification is described below: A fault situation is classified into a class 0 if the corresponding fault is not relevant to autonomous movement. The fault is then documented only in the fault memory. Further movement of the agricultural machine is triggered as a response. For example, if a dusty camera is recognized as a fault situation that does not impair the further movement, only a warning is issued so that an operator can clean the camera at the next opportunity.

A fault situation is classified into a class 1 if autonomous movement is impaired. As a response, the traction drive then changes (by corresponding actuation of the self-driving unit) to a remote-controlled operation, and the agricultural machine slowly stops. For example, if a camera sensor is defective and this impairs the further movement, the agricultural machine remains stationary.

A fault situation is classified into a class 2 if autonomous operation is impaired more severely. The traction drive then changes to a remote-controlled operation in response, and a strong braking action is triggered. For example, if an obstacle is recognized at a distance of 20 m, this will lead to strong braking.

A fault situation is classified into a class 3 if a danger to the agricultural machine or to an object in the surroundings is recognized. In response, the traction drive then changes to a remote-controlled operation and performs emergency braking. For example, if an obstacle is recognized directly in front of the agricultural machine, this triggers emergency braking.

In this exemplary classification, a change in an operating state of the agricultural machine is triggered automatically in classes 1 to 3 in each case. The autonomous operating state is in particular exited. In class 0, the agricultural machine remains in the autonomous operating state. In each fault situation, an operator of the agricultural machine is preferably informed, for example via a telemetry system, regardless of the classification.

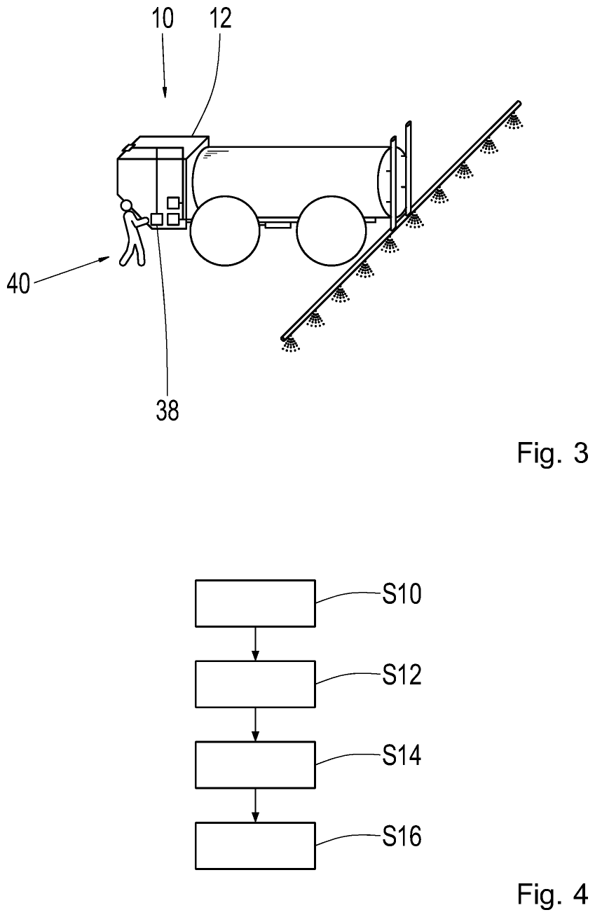

FIG. 3 schematically shows an optional development of the agricultural machine 12 comprising the system 10. The agricultural machine additionally comprises an operator interface 38, which enables an interaction with a (human) operator 40. For example, a button, a touch screen display, or a lever may be provided. An input from an operator can be requested via the operator interface 38. For example, in the case of a soiled sensor, it may be necessary to request a confirmation from the operator 40 that the operator has eliminated the soiling. This request can be part of the response of the agricultural machine to a recognized fault situation.

FIG. 4 schematically shows a method for safely operating an autonomously operable agricultural machine. The method comprises steps of receiving S10 a sensor signal, recognizing S12 a fault situation, assigning S14 the recognized fault situation to a fault class, and periodically transmitting S18 a message to a control device. The method can be implemented, for example, as software that is executed on a vehicle control device of the agricultural machine. It is also possible for the method to be implemented as software for a mobile device (smartphone app). The method may be completely or partially cloud-based.

The subject matter of the present disclosure has been extensively described and explained with reference to the drawings and the description. The description and explanation are to be understood as exemplary and not limiting. The invention as defined by the claims is not limited to the disclosed embodiments. Other embodiments or variations become apparent to those skilled in the art, and from a precise analysis of the drawings, the disclosure, and the claims to follow.

In the claims, the words “comprise” and “with” do not exclude the presence of further elements or steps. The indefinite article “a” or “an” does not exclude the presence of a plurality. A single element or a single unit can perform the functions of a plurality of the units mentioned in the claims. An element, a unit, an interface, a device, and a system may be partially or completely implemented in hardware and/or in software. The mere mention of some measures in a plurality of different dependent claims is not to be understood as meaning that a combination of these measures cannot likewise be used advantageously. A computer program can be stored/distributed on a non-volatile data carrier, for example on an optical memory or on a solid state drive (SSD). A computer program may be distributed together with hardware and/or as a hardware component, for example by means of the Internet or by means of wired or wireless communication systems. Reference symbols in the claims are not to be understood as limiting.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 System
12 Agricultural machine
14 Device
16 Control device
18 Environment sensor
20 Vehicle bus system
22 Self-driving unit
24 Implement
26 Liquid tank
28 Nozzle
30 Input interface
32 Processing unit
34 Classification unit
36 Transmission interface
38 Operator interface
40 Operator

1. A device for safely operating an autonomously operable agricultural machine, the device comprising:
an input interface configured to receive a sensor signal from an environment sensor on the agricultural machine, the sensor signal comprising information about objects in the surroundings of the agricultural machine;
a processor configured to recognize a fault situation based on the sensor signal;
a classification unit configured to assign the recognized fault situation to a fault class based on a predefined assignment rule; and
a transmission interface configured to periodically transmit a message to a control device of the agricultural machine via a vehicle bus system of the agricultural machine, the message comprising the fault class.

2. The device according to claim 1, wherein the input interface is configured to receive the sensor signal via the vehicle bus system.

3. The device according to claim 1, wherein the predefined assignment rule is based on a risk resulting from the fault situation for the agricultural machine and for objects in the surroundings of the agricultural machine; and
wherein a higher risk entails a higher fault class.

4. The device according to claim 1, wherein the transmission interface is designed to transmit a further message before the expiration of a regular time period if two fault situations are recognized.

5. The device according to claim 1, wherein the input interface is designed to receive a status message of the control device of the agricultural machine via the vehicle bus system-.

6. The device according to claim 1, wherein the processor is configured to ascertain a fault location and/or a fault type;
wherein the classification unit is configured to assign the recognized fault situation to a fault class based on the ascertained fault location and/or the ascertained fault type; and
wherein the transmission interface is configured to periodically transmit the message with the ascertained fault location and/or the ascertained fault class.

7. The device according to claim 1, wherein the classification unit is configured to ascertain a response of the agricultural machine to the recognized fault situation; and
wherein the transmission interface is configured to periodically transmit the message with the ascertained response.

8. A system for safely operating an autonomously operable agricultural machine, the system comprising:
the device according to claim 1;
the environment sensor configured to recognize objects in the surroundings of the agricultural machine; and
the control device, configured to receive the message and control a self-driving unit and/or an implement of the agricultural machine based on the received message.

9. The system according to claim 8, wherein
the control device is configured to set an operating state of the agricultural machine;
the control device is configured to change from an autonomous operating state, in which the agricultural machine operates autonomously, into a remote-controlled operating state, in which the agricultural machine can be controlled remotely, if the fault class satisfies a predefined state condition.

10. The system according to claim 8, wherein the control device is configured to brake the agricultural machine if the fault class satisfies a predefined braking condition; and
wherein the control device is configured to ascertain a braking force based on the fault class and to brake the agricultural machine with the ascertained braking force.

11. The system according to claim 8, further comprising an operator interface configured to receive an input from an operator,
wherein the control device is designed to request an operator command via the operator interface if the fault class satisfies a predefined input condition.

12. The system according to claim 8, wherein the classification unit is configured to ascertain a response of the agricultural machine to the recognized fault situation; and
wherein the transmission interface is configured to periodically transmit the message with the ascertained response, and
wherein the control device is configured to carry out the response.

13. An autonomously operable agricultural machine, comprising:
a system according to claim 8;
the vehicle bus system; and
a self-driving unit configured to move the agricultural machine and/or an implement configured to carry out an agricultural task.

14. A method for safely operating an autonomously operable agricultural machine, the method, comprising:
receiving a sensor signal of an environment sensor on the agricultural machine with information about objects in the surroundings of the agricultural machine;
recognizing a fault situation based on the sensor signal;
assigning the recognized fault situation to a fault class based on a predefined assignment rule; and
periodically transmitting a message to a control device of the agricultural machine via a vehicle bus system of the agricultural machine, wherein the message comprises the fault class.

15. A computer program product having stored thereon computer executable program code comprising instructions for carrying out the method according to claim 14.
